(19) United States
(12) Patent Application Publication
(10) Pub. No.: US 2010/0083597 A1
(43) Pub. Date: Apr. 8, 2010

(54) FENESTRATION COVERING AND FENESTRATION ASSEMBLY

(76) Inventors: Jeffrey C. Addison, Valley (CA); Vince Maccormack, Debert (CA)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/572,481

(22) Filed: Oct. 2, 2009

(30) Foreign Application Priority Data
Oct. 3, 2008 (CA) 2,640,315

(51) Int. Cl. E06B 3/30; E06B 3/964; B44F 9/02

(52) U.S. Cl. 52/204.53; 52/204.62; 52/313

(57) ABSTRACT

An interior sash covering gives a vinyl sash the mortise and tenon look of a traditional wood window. The covering can be equipped with an optional decorative coating, such as wood, while retaining the advantages of the strength and durability associated with vinyl. The invention also relates to fenestration assemblies containing the same. As the covering of the present invention is not involved in the glazing process, a e.g. insulated glass unit, may be replaced without the need to destroy the decorative covering.

### BACKGROUND OF THE INVENTION

The invention relates to fenestration assemblies. In particular, the invention relates to an interior sash covering which gives a vinyl sash the mortise and tenon look of a traditional wood window, with an optional decorative coating, with the advantages of the strength and durability associated with vinyl. The invention also relates to fenestration assemblies containing the same. The invention is in the scope of mechanical engineering and is applicable to the fenestration industry.

Customers are increasingly demanding larger windows with a decorative finish, such as wood. Windows with an all wood assembly have the attraction of presenting an appealing wood face to the interior of the home, which in many cases is desirable and coincides with the interior design tastes of the home owner. However, the discerning tastes of a large number of home owners is also resulting in the additional request that the wood finish of the windows does not have the appearance of knots and joints. Due to the increasing demand on the lumber industry for this and numerous other applications, it is becoming increasingly difficult to harvest large quantities of clear pine and other species. Accordingly, the lumber industry cannot provide the required material at competitive pricing, making window assemblies that are constructed entirely out of wood expensive to manufacture, install and maintain.

An alternative is the use of wood veneer products in the production of windows. Window assemblies that are essentially made out of a plastic or vinyl material can have wood coating or covering elements on the interior of the window, providing for a window that is strong and reliable, as is the current standard with vinyl windows, while also incorporating the desired wood finish to appease the home owner. These products also have the economical advantage in that the assembly is not entirely fabricated from wood, thus decreasing the cost associated therewith. Furthermore, wood coating and/or covering products are currently available in a wide selection of species, free of knots, with minimally visible joints, and are thus able to accommodate most decor requirements.

One of the issues surrounding the use of wood coating or covering elements on the interior of window assemblies is that wood and various other materials that may be used as a coating or covering element do not have the same physical properties as vinyl, and thus, can not be fusion welded. However, the process of fusion welding of vinyl window frames and sashes is the industry standard. Accordingly, this is an obstacle that needs to be addressed.

There have been various incarnations within the prior art where attempts have been made to provide a device to address the above-mentioned problems.

The sash of a half wood half vinyl double hung window found in the prior art, and manufactured by the present Applicant, Kohltech, is comprised of vinyl exterior and wood interior components. The vinyl portion of the sash is designed to seat the glass with an interior wood attachment to hold the insulated glass unit in place; this type of arrangement is referred to as interior glazing. Wood components are attached by silicone and mechanical fasteners. However, it must be noted that removing the glazing stop from this system is not possible without causing irreparable damage to the product. In the event of a seal failure or a broken insulated glass unit, simple replacement is not possible, so a complete sash has to be manufactured and shipped to the customer. An additional deficiency to note is the fact that wood and vinyl have different thermal expansion properties. This results in a product that is more prone to warping and rotting.

U.S. Pat. No. 6,263,626 (Gerhardt) discloses a window or door sash of the type having a sash frame for receiving a transparent sheet, which is retained in the sash frame by a plurality of removably mounted glazing beads. A variety of covering members can be attached to the glazing beads, providing a covering for both the glazing bead and the sash on the interior surface of the window assembly. Typically, the lack of mechanical fasteners in the attachment of the covering to the glazing bead minimizes the effects of differing thermal expansion properties of the materials. However, when the means of attachment includes mechanical fasteners, such as silicone or two sided tape, there is a substantial increase in the difficulty of deglazing the windows. Thus, the Gerhardt design has a direct impact on the glazing of the windows.

U.S. Pat. No. 5,603,585, assigned to the Andersen Corporation, discloses a mortise and tenon joint structure of a vinyl sash. U.S. Pat. No. 5,837,095, also assigned to Andersen Corporation, discloses a welding fixture design that is capable of connecting framing components, such as sash members for a window. In these designs, the interior of the sash has a mortise and tenon joint and the exterior is a 45 degree miter joint. The rails and stiles are milled to shape and to be fusion welded. This provides a continuous vinyl frame with interior mortise and tenon joinery. However, the insulated glass unit (IGU) is welded directly into the sash thus not addressing the deglazing issue. In addition, there is no indication the sash could be comprised of part wood and part vinyl. Thus, the traditional wood look is not achieved. It is an object of the present invention to address the deficiencies found within the prior art.

### SUMMARY OF THE INVENTION

The present invention overcomes the aforementioned deficiencies by the nature of its design. One embodiment of the present invention will be an exterior glazed vinyl sash with an interior cover that is decorative and adds structural performance characteristics to the product. The sash preferably will be of continuous vinyl composition and fusion welded. The covering can provide an additional continuous weather seal not present in existing half wood, half vinyl designs. The glazing bead is kept free from any covering, which facilitates the deglazing process. Therefore, if the insulated glass unit needs to be replaced, the exterior glazing stop, such as a glazing bead, can be removed, and the glass unit replaced, without impact to the interior finish.

According to an aspect of the present invention, there is provided a fenestration covering to cover the interior surface of a sash, the covering comprises means for attachment to the sash, wherein the covering member is intimately associated with the sash and is dimensioned and adapted to provide a continuous weather seal to a fenestration assembly.

According to another aspect of the present invention, there is provided a fenestration assembly comprising; a sash for retaining a glass unit; glazing beads removably attached on the exterior surface of the sash for securing the glass unit in the sash; a covering member, which is attached to the sash and covers at least the interior surface of the sash, wherein the covering member is intimately associated with the sash and is dimensioned and adapted to provide a continuous weather seal to the fenestration assembly.

According to another aspect of the present invention, there is provided a fenestration covering member comprising a means for attachment to a sash; and a glazing lip terminating at the end of the fenestration covering member which spans the portion of the sash that will be situated on the interior of a building; wherein the cross-section of the fenestration covering member is substantially L-shaped and when installed is in intimate contact with the sash and is dimensioned and adapted to provide a continuous weather seal to a fenestration assembly.

According to another aspect of the present invention, there is provided a fenestration assembly comprising at least one sash for retaining a window pane or glass unit; glazing beads removably attached on the exterior surface of the at least one sash for securing the window pane or glass unit in the at least one sash; and at least one fenestration covering member as defined herein, which is attached to the at least one sash and covers at least an interior surface of the at least one sash; wherein the at least one sash has a corresponding means for attachment to the at least one fenestration covering member to allow for a secure mating engagement; and wherein the at least one fenestration covering member and the at least one sash are made of the same material.

According to an embodiment of the present invention, the covering may have a decorative coating. The decorative coating is present on the covering such that when the covering is properly installed on the sash, the decorative coating faces the interior of a dwelling. Preferably the decorative coating is wood or a wood veneer.

A further embodiment of the present invention provides for at least one T-slot in the covering. Said T-slot will allow for the addition of insulation and/or weather stripping to the covering, promoting the covering from a decorative item to a functional one.

A better understanding of the present invention and its objects and advantages will become apparent to those skilled in this art from the following detailed description, wherein there is described only the preferred embodiment of the invention, simply by way of illustration of the best mode contemplated for carrying out the invention. As will be realized, the invention is capable of modifications in various obvious respects, all without departing from the scope and spirit of the invention. Accordingly, the description should be regarded as illustrative in nature and not as restrictive.

### BRIEF DESCRIPTION OF THE DRAWINGS

FIG. 1A is a cross section view of one embodiment of a fenestration covering of the present invention in relation to a sash;

FIG. 1B illustrates a cross section view of the fenestration covering in operable contact with a sash;

FIG. 2A is a cross section view of another embodiment of a fenestration covering of the present invention in relation to a sash;

FIG. 2B illustrates a cross section view of the fenestration covering in operable contact with a sash;

FIG. 3 is a cross section view of an aspect of the present invention utilized in an exemplary embodiment, in connection with a double hung window; and

FIGS. 4A and 4B are front views of a sash with or without the covering of the present invention, respectively, as viewed from the interior space of a domicile in which the sash is installed.

### DETAILED DESCRIPTION OF THE PREFERRED EMBODIMENT

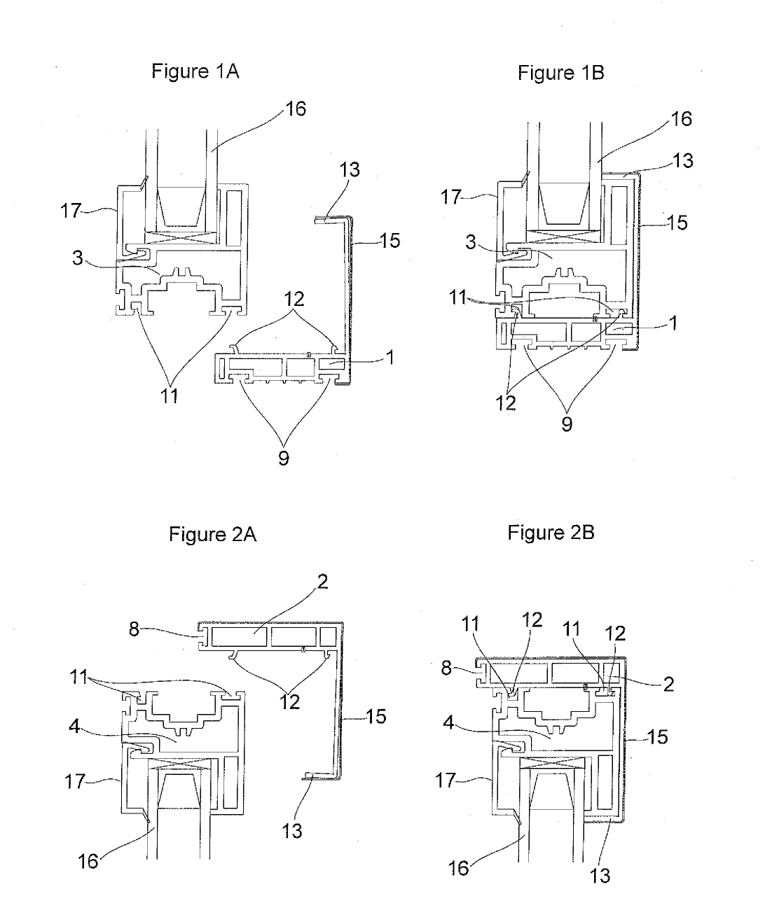

FIGS. 1A and 2A illustrate fenestration coverings (1,2) according to an aspect of the present invention and the coverings (1,2) are presented in fitted relation to a sash (3,4). The sash (3,4) is fabricated in a manner known to one of skill in the art, such that, e.g. a window pane or an insulated glass unit (16), can be situated therein. Preferably the sash (3,4) is of a continuous vinyl composition and is fusion welded. However, according to the present invention, in order to glaze the insulated glass unit (16), e.g. glazing beads (17), are situated on the side of the insulated glass unit (16) and sash (3,4) which is to face the exterior of a dwelling, thus securing the, e.g. insulated glass unit (16), within the sash (3,4). According to this exemplary embodiment of the invention, if the glass unit (16) becomes damaged, or needs to be replaced for any reason, the deglazing process is performed from the exterior of the dwelling.

As can be seen from FIGS. 1A and 2A, the cross section of the coverings (1, 2) are preferably substantially L-shaped in design, however, variations thereof are contemplated in order to conform to the dimensions of, and intimately contact, a sash (3,4) to be covered. The thickness of any of the portions of the coverings (1,2) are not particularly limiting. Terminating at the end of the covering (1,2), which spans the portion of the sash (3,4) that will be situated on the interior of a building, is a glazing lip (13).

The covering (1,2) has attachment means to secure it to the sash (3,4). In the embodiment as illustrated, the attachment means are located on the portion of the covering (1,2), which will contact and engage the side of the sash (3,4) opposite the side where the window is secured. In other words, the side of the sash that is likely to abut a window frame. However, the exact location of the attachment means is only limited by the requirement that the corresponding location on the sash (3,4) is capable of receiving the attachment means. Preferably the attachment means take the form of engagement legs (12), however, any alternative form of attachment means, such as snap means or variations of male-female mating means, or any additional type of attachment means known to one of skill in the art for that matter, may be employed while still remaining within the scope of the present invention.

In embodiments where engagement legs (12) are employed by the coverings (1, 2), corresponding receptor channels (11) are prefabricated into the sash (3,4) to allow for mating engagement. Of course, the coverings (1,2) may be designed to fit pre-existing sashes (3,4), and as such, the placement and the nature of the attachment means can vary accordingly, in order to securely attach the covering (1,2) to the desired sash (3,4). For example, the engagement legs (12) may appear at predetermined distances along the length of the coverings (1,2), or alternatively, the engagement legs (12) may take the form of a continuous member which extends out of the coverings (1,2) and spans the entire length of the sash (3,4). The exact nature of the engagement legs (12) is clearly dependent upon the configuration of the corresponding receptor channels (11). Thus, the nature of the receptor channels (11), such as frequency along the length of the sash (3,4), can also vary in a similar and corresponding manner.

An additional point of contact and attachment between the coverings (1,2) and the sash (3,4) is the glazing lip (13). As can be seen from FIGS. 1A and 2A, in an exemplary embodiment of the invention, the glazing lip (13) does not project perpendicularly from the section of the covering (1,2) which spans the portion of the sash (3,4) that will be situated on the interior of a building. Rather, it is preferable that the glazing lip (13) is angled downward and toward the portion of the sash (3,4) that will be situated on the interior of a building, such that the angle between this portion of the covering (1,2) and the glazing lip (13) is less than 90°. When the covering (1, 2) is installed on a sash (3,4), i.e. when attachment means, such as the engagement legs (12), are properly situated in their respective receptor channels (11), the glazing lip (13), by virtue of its downward angled positioning, will apply pressure to and clasp or hug the sash (3,4). The exact angle which the lip (13) extends downward is not particularly limiting, as long as the lip is still able to fittingly engage and clasp the sash. This additional attachment point will stabilize the covering (1,2) to the sash (3,4). Furthermore, as the glazing lip (13) will be in intimate contact with the, e.g. insulated glass unit (16), an additional layer of insulation (14) is also provided. Not only does the covering (1,2) provide the opportunity to increase the aesthetic appeal of the interior of the fenestration, but in certain aspects, it is integral to the function of the fenestration.

It is contemplated that the covering (1,2) should contain at least one T-slot (8, 9). The T-slot (8, 9) is effectively a channel or groove which preferably runs the length of the covering (1,2), in the outer portion of the coverings (1,2). The T-slot (8,9) provides the ability to apply additional layers of insulation (14) or weatherstripping to the fenestration. Such additional layers of insulation (14) or weatherstripping may, for example, take the form of weather pile or Q-Lon®, however, any comparable type of insulation and/or weatherstripping (14) known to one of skill in the art may also be utilized. The installation of the insulation and/or weatherstripping is not particularly limiting, and can be carried out according to standard techniques in this field of endeavor, such as applying the insulation and/or weatherstripping (14) to the T-slot (8,9) with an adhesive, or with a mechanical fastener, such as staples. The benefit to this aspect of the invention is that not only will the covering (1,2) provide aesthetic qualities to the interior portion of the sash (3,4), but it will also significantly bolster the insulating capacity of sash (3,4), and in turn, the fenestration assembly as a whole. As indicated above, the covering of the present invention is not merely a cladding, but also can serve as a structural portion of the fenestration, as exemplified by its ability to substantially upgrade the insulating capacity of the fenestration assembly. This particular aspect of the present invention provides the manufacturer with flexibility as to which weather sealing components to use, and thus, desired air and water leakage levels can be obtained and/or manipulated.

FIGS. 1B and 2B depict the covering (1,2) attached to the sash (3,4). As can be seen in these exemplary embodiments, the attachment means, i.e. the engagement legs (12) are matingly engaged with the receptor channels (11) of the sash (3,4). It is critical that the coverings (1,2) fit the sash (3,4) securely, but not too tightly, when tolerances of either or both the sash (3,4) and covering (1,2) are at the extreme. If any of the components are too loose there could be significant air leakage through the fenestration to the interior of the home. Conversely, a window system that is too tight will not allow for proper pressure equalization and water leakage is a likely result. Furthermore, the glazing lip (13) must be of a specific length to produce a clean, tight line between the covering (1,2) and the, e.g. insulated glass unit (16), but not too tight to cause stress to the, e.g. insulated glass unit (16).

The material utilized for the fabrication of the covering (1,2) itself is not particularly limiting, and may be such materials as fiberglass, aluminum, vinyl and various composite materials. Preferably, the material is identical to the material of which the sash (3,4) is fabricated, in order to allow for concomitant thermal expansion of both the sash (3,4) and the covering (1,2) in a harmonious fashion. Finally, it is preferable to color match the covering (1,2) to existing vinyl components from an aesthetic point of view.

As can be seen from the figures, it is preferable that a decorative coating (15) be applied to the face of the covering (1,2). In particular, the decorative coating (15) is applied to the face which is directed toward the interior of a building when said covering (1,2) is properly installed on a fenestration. The decorative coating (15) may also extend to cover the glazing lip (13) such that the entirety of the interior portion of the sash presents the coating (15). It is contemplated that various different decorative coatings (15) can be utilized within the scope of the present invention, such as wood or a wood veneer, paint, vinyl foil or leather. Alternative decorative coatings (15) not explicitly noted may also be utilized, depending on the aesthetic tastes of the end user. Preferably, the decorative coating (15) is wood or a wood veneer. All types of wood that would be considered suitable for this application by one of skill in the art are contemplated within the present invention. However, it is also possible that no decorative coating (15) be applied to the covering (1,2), and thus, the interior finish of the covering (1,2) would be represented by whatever material the covering (1,2) is fabricated therefrom. The glazing lip (13) also allows any decorative coating (15) that may be applied to the covering (1,2) to extend to the, e.g. insulated glass unit (16), thus allowing the interior portion of the sash (3,4) to be covered decoratively in its entirety.

Minor modifications may be effected to the covering (1,2) while still residing within the scope of the present invention. For example, a common sash covering (1) is illustrated in FIGS. 1A, 1B, whereas a meeting rail covering (2) is illustrated in FIGS. 2A, 2B. One of the main variations between these two embodiments of the present invention is their preferred role and location within a fenestration assembly, and this is manifested in their varied optional physical attributes.

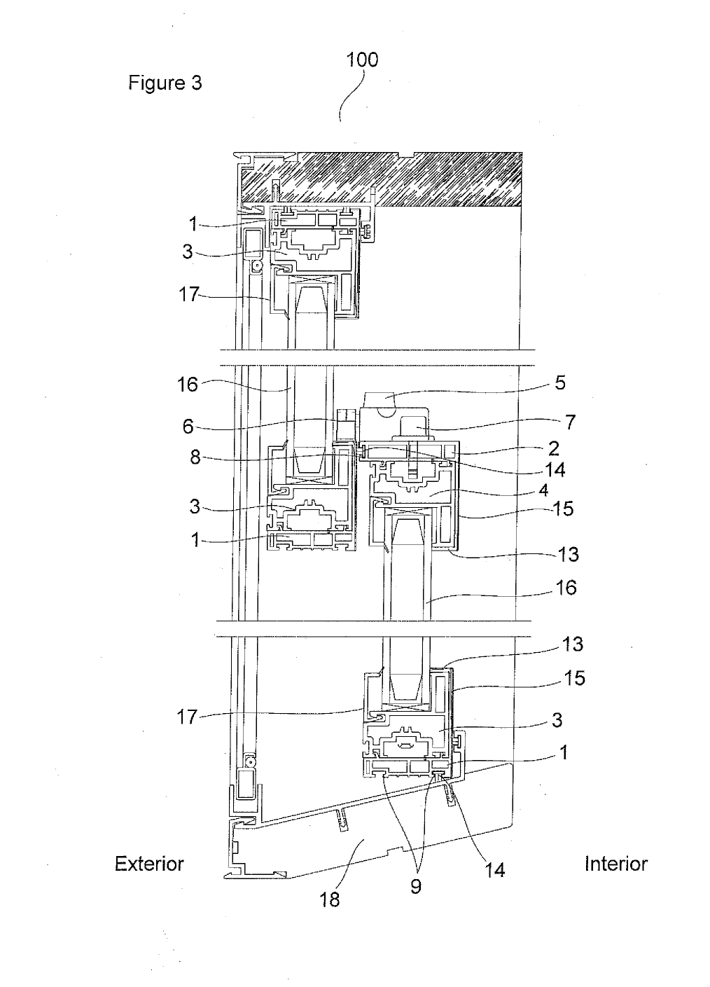

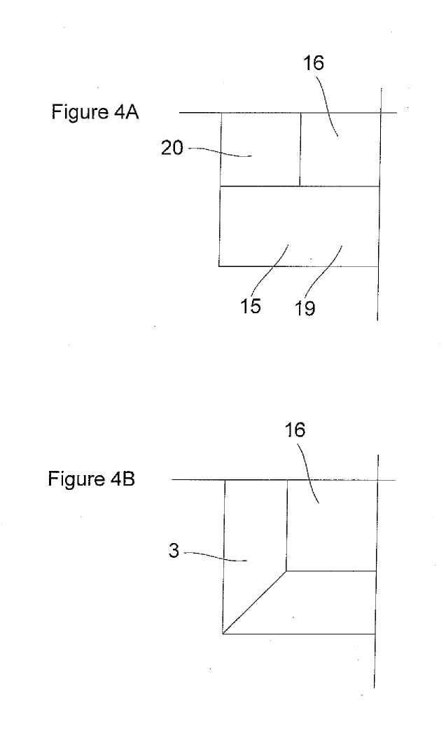

With reference to the exemplary embodiment illustrated in FIG. 3, the common sash covering (1) is typically utilized on the sash (3) for all of the rails (19) and stiles (20) of the outer glass unit (16) and on the sash (3) for both stiles (20) and the lower rail (19) of the inner glass unit (16) of, in this case, a double hung window. Accordingly, most of these coverings (1,2) will be in intimate association with the window frame (18). Thus, the location of the T-slot (8,9) on the common sash covering (1), which are intended to house, e.g. additional weatherstripping, are located on the face of the covering (1), which will contact and engage the side of the sash (3) opposite the side where the window is secured. In other words, the T-slot (8,9) on the common sash covering (1) is/are located in a position where the, e.g. additional weatherstripping, can be in intimate contact with the frame (18) of a fenestration assembly, providing an additional inherent layer of protection (see FIG. 3).

In contrast, with reference to the exemplary embodiment illustrated in FIG. 3, the meeting rail covering (2) is typically only utilized on the upper rail (19) of the lower sash (4) of the inner glass unit (16) of, in this case, a double hung window. This covering (2) typically is not in contact with the window frame (18), but rather is at the contact point or breach point between the two adjacent glass units (16) when both glass units (16) are fully closed. Accordingly, the T-slot (8,9) of the meeting rail covering (2) is not in the same position as that of the common sash covering (1) as it would serve little to no practical purpose if it were. Instead, the T-slot (8,9) of the meeting rail covering (2) is preferably located on the surface of the covering (2) which faces the exterior, i.e. the side of the covering (2) which is in close contact with the outer glass unit (16). In other words, when the weather pile (14) is in the T-slot (8,9), it extends in a direction transverse to the plane of the glass unit (16), and toward the bottom sash (3) of the outer glass unit (16). This positioning will allow for the e.g. additional weatherstripping, to contact the outer glass unit (16), fortifying any breach or gap contained therein when the window is in the fully closed position.

Furthermore, the positioning of the meeting rail covering (2) in a double hung window, as exemplified in FIG. 3, may require that, e.g. a lock (5) and/or a tilt latch assembly (7) be installed on the face of the covering (2), which will contact and engage the side of the sash (3) opposite the side where the, e.g. glass unit (16), is secured. In this instance, it is preferred that this portion of the covering (2) does not have a T-slot (8,9), but rather, a flat finished surface that is adapted to receive the lock (5) and/or tilt latch assembly (7). The manner in which the lock (5) and tilt latch assembly (7) as illustrated in FIG. 3 are secured to the meeting rail covering (2) is not particularly limiting, and any mechanical fastener, such as a screw, should suffice. Preferably, the lock (5) and/or tilt latch assembly (7) are installed over the covering (2). However, it is also contemplated within the present invention that any such locking mechanism known to one of skill in the art could be used interchangeably.

The manner in which the decorative coating (15) is applied to the interior face of the covering (1,2) is not particularly limiting. However, as the covering (1,2) itself is able to provide an additional layer of insulation (14) to the fenestration, it is preferred that the means for attaching the decorative coating (15) does not compromise the integrity of the covering (1,2), such as with mechanical fasteners, e.g. nails, screws, staples, etc. Rather, it is preferable that some sort of adhesive is used to attach the decorative coating (15) to the covering (1,2), such as glue, double-sided tape, or any other adhesive appropriate for such an application known to one of skill in the art. This will safeguard against introducing any points of entry for airflow in to the interior of a dwelling.

As previously alluded to, the present invention provides the ability to deglaze and/or replace a damaged window without having to disturb or destroy the covering (1,2) and the decorative coating (15) on the interior of a dwelling. The deglazing can occur from the exterior of the fenestration assembly, such as by removing the glazing beads (17), and the e.g. insulated glass unit (16), can be replaced, and the entire assembly reglazed from the exterior. Thus, although the covering (1,2) and assembly of the present invention provide additional layers of insulation (14) to the fenestration assembly as a whole, it is not directly involved in the glazing process per se. Accordingly, the present invention addresses some of the deficiencies found in the prior art.

An embodiment of the present invention is illustrated in FIG. 3. In particular, a cross section of a fenestration assembly (100), herein exemplified as a double hung window, is shown, which incorporates exemplary embodiments of the fenestration coverings (1,2) of the present invention. An operational double hung window incorporates multiple embodiments of the covering (1,2) of the present invention. Each glass unit (16) itself requires four coverings (1,2) per sash (3), two rail (19) coverings and two stile (20) coverings. All four sides of the sash (3), i.e. both rails and both stiles, of the upper insulated glass unit (16) are covered entirely with the common sash covering (1) as illustrated and exemplified in FIG. 1A. The lower rail and both stiles of the lower sash (4) of the lower insulated glass unit (16) are also covered with the common sash covering (1) as illustrated and exemplified in FIG. 1A. As indicated above, the use of the common sash covering (1) at these specific locations utilizes the locations of the T-slot (8,9), in that weather pile (14) inserted therein serves to seal any junctions between the covering (1) and/or sash (3) and the window frame (18). However, the upper rail (19), i.e. the meeting rail, of the lower sash (4) of the lower glass unit (16) incorporates a meeting rail covering (2) as illustrated and exemplified in FIGS. 2A and 3. As indicated above, the use of the meeting rail covering (2) at this specific location utilizes the location of the T-slot (8,9), in that weather pile (14) inserted therein serves to seal any junctions between the inner and outer glass units (16). Also, the meeting rail covering (2) is adapted to receive a lock (5) and/or tilt latch assembly (7) in such a manner that it is able to meet and matingly engage a keeper (6) that is located on the interior side of the lower rail of the outer glass unit (16) when the window is in the closed position. In this exemplary embodiment, the keeper is located on a glazing lip (13), however, any position along the outer glass unit (16) may be chosen for the location, providing that a secure locked state can be obtained.

To install the coverings (1,2) of the present invention, for example, on a window, the coverings (1,2) are cut to length so the rail (19) covers fit the full width of the sash (3), and the stile (20) covers fit the height of the sash (3), minus an appropriate adjustment for the width of both rail (19) covers. Alternatively, the opposite case also holds true, i.e. where the stile (20) covers fit the full height of the sash (3), and the rail (19) covers fit the width of the sash (3), minus an appropriate adjustment for the height of both stile (20) covers. Once the coverings (1,2) are fitted onto the sashes (3), the visual look of the sash (3) as viewed from an interior position will shift from, e.g. a 45 degree mitered joint of the sash (3), as is the standard with most fabricated fenestration sashes (3) to the more traditional wood window look of a mortise and tenon joinery, while concomitantly still providing a 45 degree fusion welded miter on the exterior.

After the sash (3) has been fusion welded, cleaned and glazed, the coverings (1,2) are installed on the main sash (3). When installing a cover, it is critical that the engagement legs (12) are fully engaged in the receptor channels (11), and that the glazing lip (13) is appropriately attached to the sash (3), as in this embodiment of the invention, these are the sole mechanical attachment points between the coverings (1,2) and the sash (3). Once the coverings (1,2) are properly attached, the e.g. weather pile, is inserted in the T-slots and secured in place. The sash (3) is then installed in the frame (18) and tested for fit and function.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A fenestration covering member comprising:
a means for attachment to a sash; and
a glazing lip terminating at the end of the fenestration covering member which spans the portion of the sash that will be situated on the interior of a building;
wherein the cross-section of the fenestration covering member is substantially L-shaped and when installed is in intimate contact with the sash and is dimensioned and adapted to provide continuous weather seal to a fenestration assembly.

2. A fenestration covering member according to claim 1 further comprising: at least one T-slot in the fenestration covering member which spans the portion of the sash that will be situated on the exterior of the building for allowing the addition of insulation or weather stripping to the fenestration covering member.

3. A fenestration covering member according to claim 1, wherein the means for attachment are engagement legs.

4. A fenestration covering member according to claim 1, wherein the fenestration covering member is made of fiberglass.

5. A fenestration covering member according to claim 1, wherein the fenestration covering member is made of vinyl.

6. A fenestration covering member according to claim 1, wherein the fenestration covering member is made of aluminum.

7. A fenestration assembly comprising:
at least one sash for retaining a window pane or glass unit;
glazing beads removably attached on the exterior surface of the at least one sash for securing the window pane or glass unit in the at least one sash; and
the at least one fenestration covering member as defined in claim 1, which is attached to the at least one sash and covers at least an interior surface of the at least one sash;
wherein the at least one sash has a corresponding means for attachment to the at least one fenestration covering member to allowing for a secure mating engagement.

8. A fenestration assembly according to claim 7, wherein the at least one fenestration covering member and the at least one sash are made of the same material.

9. A fenestration assembly according to claim 7 further comprising: a decorative coating;
wherein when the decorative coating is present on the at least one fenestration covering member and the at least one fenestration covering member is properly installed on the at least one sash, the decorative coating faces the interior of a dwelling; and
wherein the decorative coating is affixed to the at least one fenestration covering member by an adhesive.

10. A fenestration assembly according to claim 9, wherein the decorative coating is wood or a wood veneer.

11. A fenestration assembly comprising:
at least one sash for retaining a window pane or glass unit;
glazing beads removably attached on the exterior surface of the at least one sash for securing the window pane or glass unit in the at least one sash; and
the at least one fenestration covering member as defined in claim 2, which is attached to the at least one sash and covers at least an interior surface of the at least one sash;
wherein the at least one sash has a corresponding means for attachment to the at least one fenestration covering member to allowing for a secure mating engagement.

12. A fenestration assembly according to claim 11, wherein the at least one fenestration covering member and the at least one sash are made of the same material.

13. A fenestration assembly according to claim 11 further comprising:
a decorative coating;
wherein when the decorative coating is present on the at least one fenestration covering member and the at least one fenestration covering member is properly installed on the at least one sash, the decorative coating faces the interior of a dwelling; and
wherein the decorative coating is affixed to the at least one fenestration covering member by an adhesive.

14. A fenestration assembly according to claim 13, wherein the decorative coating is wood or a wood veneer.
